(19) United States
(12) Patent Application Publication
(10) Pub. No.: US 2009/0271113 A1
(43) Pub. Date: Oct. 29, 2009

(54) METHOD FOR MODIFYING NAVIGATION INFORMATION AND NAVIGATION APPARATUS USING THE SAME

(75) Inventors: SHYANG-JYE CHANG, Taipei County (TW); Yung-yu Chen, Pingtung County (TW); Wei-ting Kuo, Tainan City (TW)

Correspondence Address: WPAT, PC, 7225 BEVERLY ST., ANNANDALE, VA, 22003, US

(73) Assignee: Industrial Technology Research Institute, Hsinchu (TW)

(21) Appl. No.: 12/129,051

(22) Filed: May 29, 2008

(30) Foreign Application Priority Data
Apr. 29, 2008 (TW) 097115765

(51) Int. Cl. G01C 21/28; G01C 21/00

(52) U.S. Cl. 701/214; 701/220

(57) ABSTRACT

A method for modifying navigation information for guiding the driver is provided in the present invention, in which attitude angle of a carrier at a specific location is detected and compared with an identifying information for judging whether the carrier is on a correct route or not. In another embodiment, the present invention further provides a navigation apparatus according the foregoing method, which comprises an inertia navigation unit, a satellite signal receiving unit, a database, and signal processing unit. The signal processing unit generates a navigation route in accordance with the start and destination and determines whether the attitude angle is conformed to the identifying information with respect to the specific location on the navigation route. If the attitude angle is not conformed to the identifying information, the signal processing unit remodifies the navigation route for the carrier.

### FIELD OF THE INVENTION

The present invention relates to a method for evaluating and modifying a navigation information, and more particularly, to a navigation information modification method and the navigation apparatus thereof capable of detecting an attitude angle of a carrier while using the detected attitude angle to determine whether the carrier is on a correct route.

### BACKGROUND OF THE INVENTION

With the development of communication construction, there are more and more underground passages and elevated roads, such as viaduct bridges, concentrated in urban area of our modem city. However, most global position system (GPS) devices currently available on the market are not accurate enough to determine whether theirs carrier had already entered an elevated road or are still driving on a surface road. Such inaccuracy often cause navigation errors to the navigation software embedded in the GPS devices that can be the main reason why people lose confidence in their ability to navigate. Please refer to FIG. 1, which shows a junction of an elevated road and a surface road. In FIG. 1, the entrance 11 of the elevated road is separated from the surface road 10 by a distance D that is only about equal to the width of a lane of the surface road 10. As the margin of error defined in most GPS devices is usually larger that the distance D, most such GPS devices are not able to identify the entrance 11 of the elevated road from the surface road 10 so that the navigation of the GPS devices will most likely lead the driver to an incorrect lane while the GPS devices trying to figure out which way to go at the bisection between the elevated road and the surface road as shown in FIG. 1. Moreover, in other complex road traffic system, such as a viaduct bridge constructed right on top of a surface road, similar navigation errors are also more than likely to happen on the on GPS devices as they are not accurate enough to determine whether the carrier is traveling on the viaduct bridge or on the surface road.

There are already many studies focus their efforts on the solving of the aforesaid navigation errors. One of which is a satellite navigation apparatus disclosed in TW 200739035, as shown in FIG. 2. The satellite navigation apparatus of FIG. 2, which is being configured in an automobile, is capable of using an accelerometer to detect the altitude variation of the automobile while sending the detection to a processing unit where it is being converted into a corresponding altitude coordinate by a double integration operation, according to which the satellite navigation apparatus is able to generate and display a navigation information on its display unit after comparing the altitude coordinate with a map database stored in its storage unit. If the movement of the automobile is defined by an X-axis, a Y-axis and a Z-axis of a Cartesian coordinate system, it is noted that the accelerometer for detecting altitude variation should be mounted at a position on the Z-axis. Nevertheless, such Z-axis accelerometer is most vulnerable to the noise originating from the vibration of the automobile itself. In addition, when the automobile is driving uphill or downhill, the gravity acceleration originating from the inclination of the automobile is going to affect the Z-axis accelerometer. Thus, the adverse affect of the vibration noise as well as the gravity acceleration upon the acceleration signal of the Z-axis accelerometer will be multiplied geometrically on the resulting altitude coordinate as it is achieved by performing the double integration operation upon the affected acceleration signal of the Z-axis accelerometer.

### SUMMARY OF THE INVENTION

The object of the present invention is to provide a method for modifying navigation information, capable of comparing an attitude angle of a carrier with an identification information of a navigation route so as to determine at the first instant whether a driver of the carrier had taken a route other than the navigation route, and thus modifying the navigation route according to the comparison for guiding the driving on a correct route to his/her destination specified in the navigation information.

The present invention further provide a navigation apparatus, being adapted for mounting on a carrier, which uses sensing components configured therein to detect an attitude angle of the carrier while comparing the current location of the carrier indicated by the detected attitude angle with an identification information, and thus providing the comparison to a navigation program embedded in the navigation apparatus for generating a navigation information to be incorporated with a map so as to be used for guiding a driver of the carrier.

In an exemplary embodiment of the invention, a method for modifying navigation information is provided, which comprises the steps of: (a) providing a navigation route to a carrier; (b) basing upon the navigation route to generate an identification information; (c) detecting an attitude angle of the carrier while the carrier is on the move; (d) determining whether the attitude angle is conformed to the identification information; (e) directing the flow to proceed back to the step (c) when the attitude angle is conformed to the identification information; (f) modifying the navigation route when the attitude angle is not conformed to the identification information.

In another exemplary embodiment of the invention, a navigation apparatus adapted for mounting on a carrier is provided, which comprises: an inertia navigation unit, capable of sensing an attitude angle of the carrier; a satellite signal receiving unit, for receiving a satellite signal; a database, for storing a communication information of road map and identification information corresponding to every specific location on the road map; and a signal processing unit, connected to the inertia navigation unit, the satellite signal receiving unit and the database, capable of generating a navigation route in accordance with a starting location and a destination and comparing the identification information of the specific location with the attitude angle for determines whether the attitude angle is conformed to the identification information so as to lo modify the navigation route when the identification information in not conformed to the attitude angle.

Yet, in another exemplary embodiment of the invention, a navigation apparatus adapted for mounting on a carrier is provided, which comprises: an inertia navigation unit, capable of sensing an attitude angle of the carrier; a satellite signal receiving unit, for receiving a satellite signal; a database, for storing a communication information of road map and identification information corresponding to every specific location on the road map; a signal processing unit, connected to the inertia navigation unit, the satellite signal receiving unit and the database, capable of generating a navigation route basing on the information stored in the database and comparing the identification information of the specific location with the attitude angle for determines whether the attitude angle is conformed to the identification information so as to modify the navigation route when the identification information in not conformed to the attitude angle; and a display device, connected to the signal processing unit, for displaying the navigation route, the modified navigation route and the information stored in the database.

Further scope of applicability of the present application will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention and wherein:

FIG. 1 shows a junction of an elevated road and a surface road.

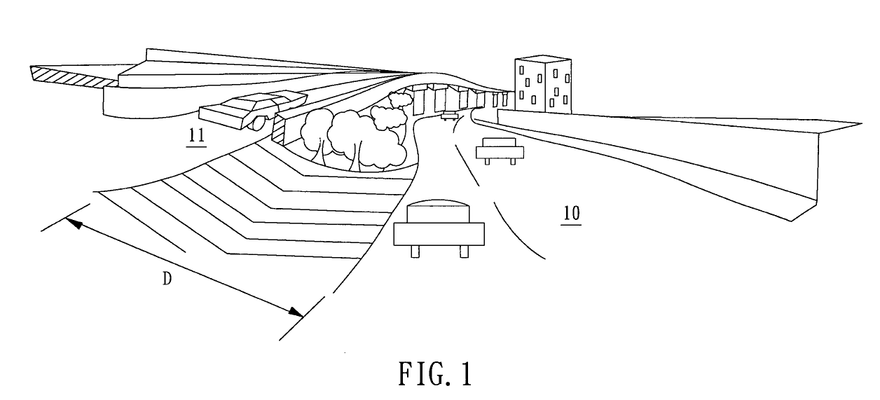

FIG. 2 shows a satellite navigation apparatus disclosed in TW 200739035

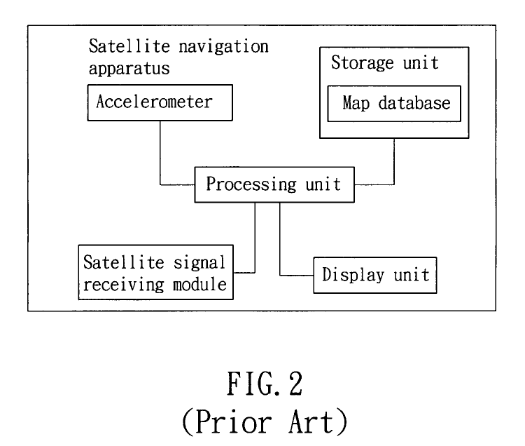

FIG. 3 is a flow chart depicting steps of a method for modifying navigation information according to the present invention.

FIG. 4A to FIG. 4C are schematic diagrams showing a traveling carrier of different attitude angles.

FIG. 5 is a schematic diagram showing a carrier being noticed by a navigation apparatus for mistakenly entering the entrance of an elevated road as it should take the neighboring surface road.

FIG. 6 is a block diagram of a navigation apparatus according to an exemplary embodiment of the invention.

FIG. 7 is a schematic diagram showing a carrier being orientated with respect to an X-axis, a Y-axis and a Z-axis of a Cartesian coordinate system for defining its attitude angle as ωₓ and turning angle as ω_{z}.

FIG. 8A and FIG. 8B are block diagrams showing two angular velocity sensing modules being adopted in the navigation apparatus of the invention.

FIG. 9 is a schematic diagram showing how the two accelerometers in a differential module are used for sensing attitude angle or turning angle.

FIG. 10 is a block diagram of an inertia navigation unit according to an exemplary embodiment of the invention.

### DESCRIPTION OF THE EXEMPLARY EMBODIMENTS

For your esteemed members of reviewing committee to further understand and recognize the fulfilled functions and structural characteristics of the invention, several exemplary embodiments cooperating with detailed description are presented as the follows.

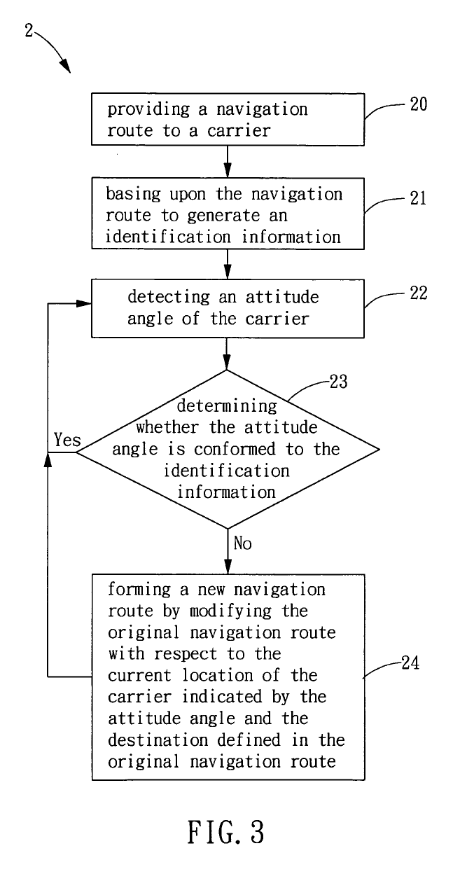

Please refer to FIG. 3, which is a flow chart depicting steps of a method for modifying navigation information according to the present invention. The flow of the method 2 starts from step 20. At step 20, a navigation route is provided to a carrier, and then the flow proceeds to step 21. There're various means capable of generating the navigation route. For instance, in those conventional GPS systems or map software, there are navigation programs embedded therein for generating navigation routes in a manner that after the coordinates e.g. the longitude and latitude, of a starting location and those of a destination, are provided to the navigation program by a user, the navigation program is able to generate and provide a navigation route to the user in accordance to how to get to the destination from the starting location in a shortest time or in a shortest distance. It is noted that the carrier can be any transportation means, and in this embodiment, the carrier is a wheeled vehicle such as cars or motorcycles, but is not limited thereby.

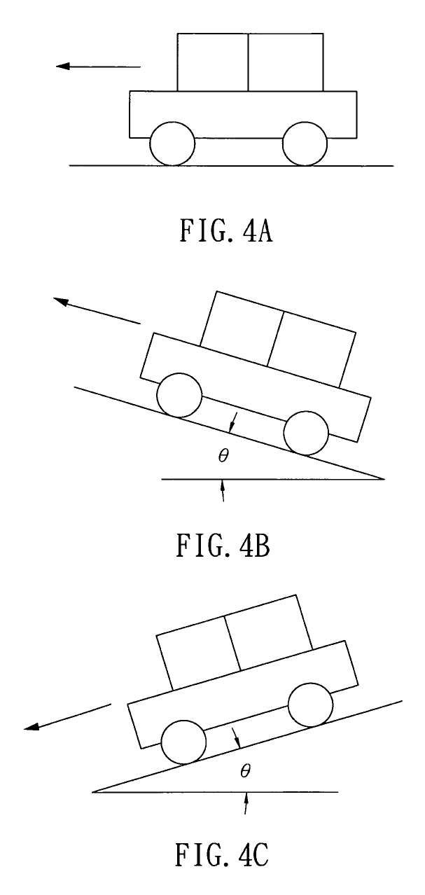

At step 21, an identification information is generated basing upon the navigation route; and then the flow proceeds to step 22. In the journey from the starting location to the destination following the given navigation route, the carrier is more than likely to encounter many different traffic conditions. For instance, the navigation route might lead the carrier to travel uphill, downhill, through an underground passage or enter an entrance of an elevated road. While encountering whichever traffic condition, the pitch angle of the carrier is inevitably going to change with the undulation of the navigation route. Please refer to FIG. 4A to FIG. 4C, which are schematic diagrams showing a traveling carrier of different attitude angles. In FIG. 4A, the carrier is traveling on a surface road so that its attitude angle is varying in a range around zero degree. In FIG. 4B, the carrier is either traveling uphill or is on its way up to enter an elevated road so that its attitude angle is varying in a range around θ degree. In FIG. 4C, the carrier is either traveling downhill or is on its way up to enter an underground passage, or is on its way out of an elevated road so that its attitude angle is varying in a range around −θ degree. Therefore, it is concluded that, in the journey from the starting location to the destination following the given navigation route, the carrier is more than likely to encounter many different traffic conditions which is going to cause the attitude angle of the carrier to change accordingly. In addition, as every traffic condition that is going to be encountered by the carrier can be considered as a known fact at the minute when the navigation route is being defined and provided to the carrier, all the attitude angles corresponding to different traffic conditions that the carrier should behave as it is traveling along the navigation route are also considered to be a known fact. That is, as soon as the navigation route is defined and provide, each traffic condition that the carrier is going to encounter in the journey, no matter it is traveling uphill, downhill or on a surface road, is related to one specific attitude angle, and the combination of all those attitude angles, each relating to a specific location in the journey is designated to be the identification information of the step 21. It is noted that for every navigation route, there will be one specific identification information. Therefore, as soon as the navigation route is determined, an identification information related specifically to the navigation route can be generated accordingly.

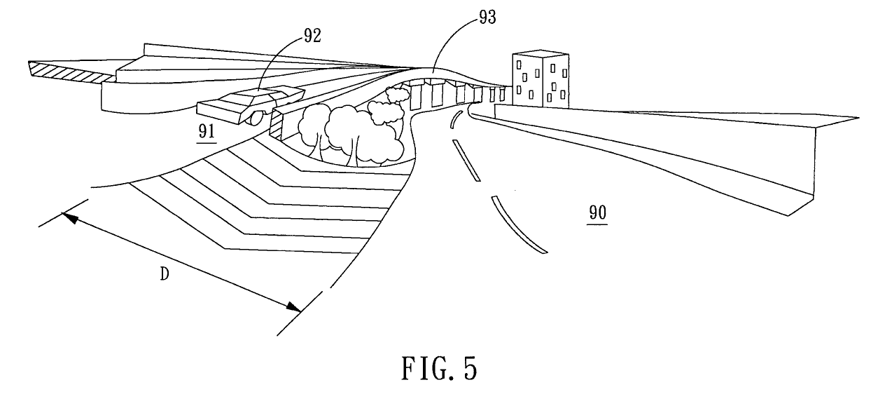

At step 22, an attitude angle is detected while the carrier is on the move; and then the flow proceeds to step 23. At step 23, the detected attitude angle is compared with the identification information corresponding to the navigation route for determining whether the attitude angle is conformed to the identification information. As the instance shown in FIG. 5, the carrier 92 being guided by the navigation route is at a location of its journey where it encounters a joint of a surface road 90 and an elevated road 93 and the carrier 92 shall take the surface road 90 so as to continue its journey as planed by the navigation route. As the entrance 91 of the elevated road 93 is separated from the surface road 90 by a distance D that is only about equal to the width of a lane of the surface road 90, it is difficult to show clearly on the navigation route that it is the surface road 90 that the carrier 92 should take and thus it is highly probable for the carrier 92 to enter the entrance 91 of the elevated road 93 by mistake. However, when the carrier 92 is driving uphill to the elevated road 93 through the entrance 91 by mistake, its attitude angle will change that it is not the zero-degree attitude angle as it is planed in the identification information so that the method of the invention is able to detect that the carrier 92 is on a wrong route by the comparison performed in the step 23.

After the comparison, if the attitude angle is conformed to the identification information, it represent that the carrier 92 is traveling as planed by the navigation route and thus the flow will proceed back to step 22 for monitoring the attitude angle of the carrier 92 in a continuing manner; otherwise, if the attitude angle is not conformed to the identification information, the flow is directed to step 24. At step 24, the navigation route is modified to form a new navigation route basing on a current location of the carrier indicated by the detected attitude angle and a destination so as to guide the carrier to travel along the new navigation route to arrive at the destination, and then the flow is directed to proceed back to the step (22) for monitoring the attitude angle in a continuing manner.

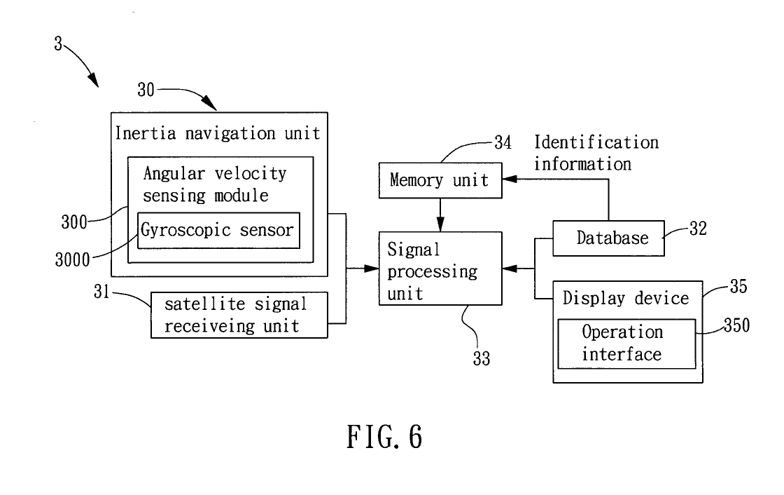

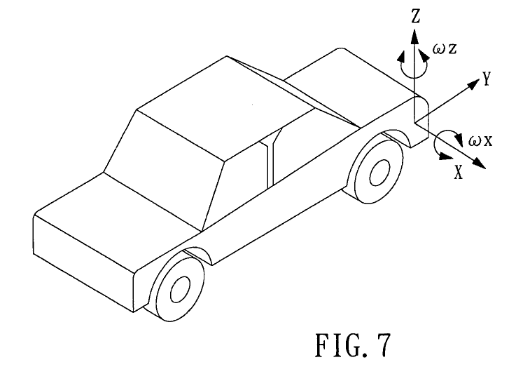

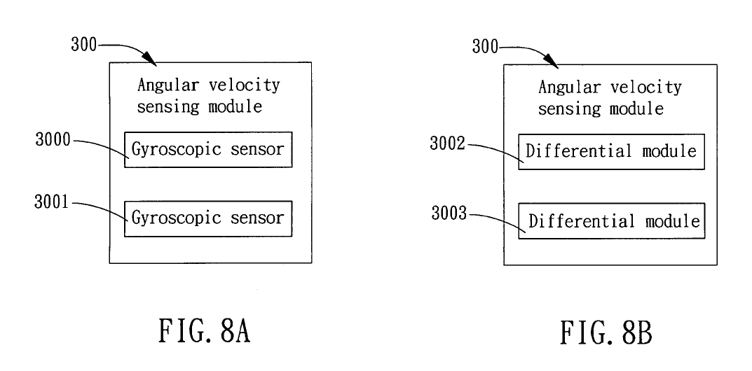

Please refer to FIG. 6, which is a block diagram of a navigation apparatus according to an exemplary embodiment of the invention. The navigation apparatus 3 is adapted to be mounted on a carrier, which can be a transportation means. In this embodiment, the transportation means is a wheeled vehicle, such as a car or a motorcycle, but is not limited thereby. In FIG. 6, the navigation apparatus 3 comprises an inertia navigation unit 30, a satellite signal receiving unit 31, a database 32 and a signal processing unit 33. The inertia navigation unit 30 is used for sensing an attitude angle of the carrier. In this embodiment, the inertia navigation unit 30 has an angular velocity sensing module 300 configured therein, which is designed for sensing at least an angular velocity with respect to an axis of a Cartesian coordinate system defining the inertia navigation unit 30. In addition, the angular velocity sensing module 300 further comprises a gyroscopic sensor 3000, which is used for detecting the attitude angle of the carrier, as the ωₓ shown in FIG. 7. In another embodiment shown in FIG. 8A, the angular velocity sensing module 300 is configured with two gyroscopic sensors 3000, 3001, in which the gyroscopic sensor 3000 is used for detecting the attitude angle of the carrier, as the ωₓ shown in FIG. 7, and the gyroscopic sensor 3001 is used for detecting a turning angle of the carrier, as the ω_{z} shown in FIG. 7.

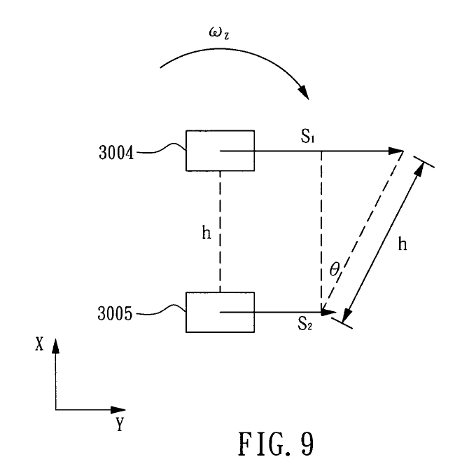

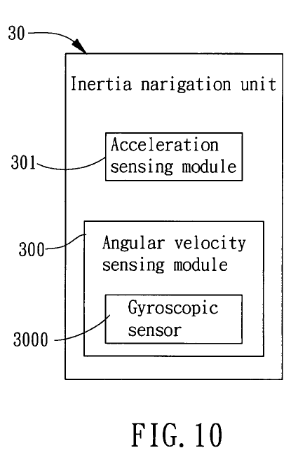

Please refer to FIG. 8B, which is block diagram showing another angular velocity sensing module being adopted in the navigation apparatus of the invention. In FIG. 8B, the angular velocity sensing module 300 is configured with two differential modules 3002, 3003, which are designed to detect the ωₓ and ω_{z} of FIG. 7 in respective for obtaining the attitude angle of the carrier therefrom. In each differential module, there is a pair of accelerometers being configured therein for detecting the acceleration variation by a differential detection scheme. Taking the detection of ω_{z} for example with reference to FIG. 9 where the paired accelerometers 3004 and 3005 are spaced from each other by a distance h, asit is able to obtain the displacement (S₁,S₂) by integrating the X-axis accelerations detected respective from the two accelerometers 3004, 3005, the variation of the angle θ with respect to the Z axis can be obtained form the geometry of the distance h and the difference between Si and S2. Please refer to FIG. 10, which is a block diagram of an inertia navigation unit according to an exemplary embodiment of the invention. In the embodiment shown in FIG. 10, the inertia navigation unit further has an acceleration sensing module configured therein for detecting the accelerations of the carrier with respect to an X-axis, a Y-axis and a Z-axis of a Cartesian coordinate system defining a free space.

As shown in FIG. 6, the satellite signal receiving unit 30 is designed for receiving a satellite signal, which is structured similar to those used in common GPS device, and thus is not described further herein. The database 32 is used for storing a communication information of a road map and identification information corresponding to every specific location on the road map, including surface roads, uphill, downhill, underground passages and viaduct bridges, etc. It is emphasized that the referring identification information is a combination of all those attitude angles, as those shown in FIG. 4A-FIG. 4C, each relating to a specific location in the journey defined in the navigation route. The signal processing unit 33, being connected to the inertia navigation unit 30, the satellite signal receiving unit 31 and the database 32, is adapted for perform the method of FIG. 3 in a manner that the navigation route can be modified properly in real time.

In this embodiment, the signal processing unit 33 is able to determine the coordinates of the carrier regarding to where exactly it is currently located basing on the information provided from the inertia navigation unit 30 and the satellite signal receiving unit 31. In addition the signal processing unit 33 is capable of generating a navigation route basing on a starting location and a destination while comparing the identification information of a specific location on the navigation route with the attitude angle detected at that specific location for determines whether the attitude angle is conformed to the identification information. When the identification information in not conformed to the attitude angle, the signal processing unit 33 will generate a new navigation route basing on a current location of the carrier indicated by the attitude angle and the destination. In another embodiment, the signal processing unit is further connected to a memory unit 34, which is used for storing the identification information corresponding to the provided navigation route for facilitating the comparison performed in the signal processing unit 33.

Moreover, the navigation apparatus further comprises a display device 35, which is connected to the signal processing unit 33 to be used for displaying the navigation route, the new navigation route and the information stored in the database. Generally, the display device 35 can be a flat panel display device such as a liquid crystal display or a light-emitting diode display device, and so on. It is noted that the display device can show an area map with a marking indicating the exact coordinates of the carrier, by which a user can easily identify the current location of the carrier. In addition, the display device 35 is designed to display an operation interface 350 thereon whose operations enables a starting location and a destination to be received by the signal processing unit 33 for defining the navigation route.

To sum up, the present invention provides a navigation information modification method and the navigation apparatus thereof that can modify a navigation route provided by the navigation apparatus in a real-time manner, by which a driver driving the carrier is informed with and guided by correct navigation information at all time during his/her journey.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method for modifying navigation information, comprising the steps of:
(a) providing a navigation route to a carrier;
(b) basing upon the navigation route to generate an identification information;
(c) detecting an attitude angle of the carrier while the carrier is on the move;
(d) comparing the detected attitude angle with the identification information for determining whether the attitude angle is conformed to the identification information;
(e) directing the flow to proceed back to the step (c) for monitoring the attitude angle in a continuing manner, when the attitude angle is conformed to the identification information;
(f) modifying the navigation route when the attitude angle is not conformed to the identification information, and then directing the flow to proceed back to the step (c) for monitoring the attitude angle in a continuing manner.

2. The method for modifying navigation information of claim 1, wherein the navigation route is defined basing on a starting location and a destination.

3. The method for modifying navigation information of claim 1, wherein the modifying of the navigation route is performed basing on a current location of the carrier indicated by the attitude angle and a destination.

4. The method for modifying navigation information of claim 1, wherein the carrier is a wheeled vehicle.

5. The method for modifying navigation information of claim 1, wherein the identification information includes all the attitude angles of the carrier as it is traveling on the navigation route, or the range of the attitude angle of the carrier as it is traveling on the navigation route.

6. A navigation apparatus, being adapted for mounting on a carrier, comprising:
an inertia navigation unit, capable of sensing an attitude angle of the carrier;
a satellite signal receiving unit, for receiving a satellite signal;
a database, for storing a communication information of a road map and identification information corresponding to every specific location on the road map; and
a signal processing unit, connected to the inertia navigation unit, the satellite signal receiving unit and the database, capable of generating a navigation route and comparing the identification information of a specific location on the navigation route with the attitude angle for determines whether the attitude angle is conformed to the identification information so as to generate a new navigation route when the identification information in not conformed to the attitude angle.

7. The navigation apparatus of claim 6, wherein the carrier is a wheeled vehicle.

8. The navigation apparatus of claim 6, wherein the identification information includes all the attitude angles of the carrier as it is traveling on the navigation route, or the range of the attitude angle of the carrier as it is traveling on the navigation route.

9. The navigation apparatus of claim 6, wherein the navigation route is defined by the signal processing unit basing on a starting location and a destination.

10. The navigation apparatus of claim 6, wherein the new navigation route is generated by the signal processing unit basing on a current location of the carrier indicated by the attitude angle and a destination.

11. The navigation apparatus of claim 6, wherein the inertia navigation unit further comprises at least a gyroscopic sensor.

12. The navigation apparatus of claim 6, wherein the inertia navigation unit further comprises at least a differential module, and each differential module further comprises a pair of accelerometers, being arranged spacing from each other by a specific distance.

13. The navigation apparatus of claim 6, further comprising:
an acceleration sensing module, further comprising at least an accelerometer.

14. A navigation apparatus, being adapted for mounting on a carrier, comprising:
an inertia navigation unit, capable of sensing an attitude angle of the carrier;
a satellite signal receiving unit, for receiving a satellite signal;
a database, for storing a communication information of a road map and identification information corresponding to every specific location on the road map;
a signal processing unit, connected to the inertia navigation unit, the satellite signal receiving unit and the database, capable of generating a navigation route basing on the information stored in the database and comparing the identification information of a specific location on the navigation route with the attitude angle for determines whether the attitude angle is conformed to the identification information so as to modify the navigation route into a new navigation route when the identification information in not conformed to the attitude angle; and
a display device, connected to the signal processing unit, for displaying the navigation route, the new navigation route and the information stored in the database.

15. The navigation apparatus of claim 14, wherein the carrier is a wheeled vehicle.

16. The navigation apparatus of claim 14, wherein the identification information includes all the attitude angles of the carrier as it is traveling on the navigation route, or the range of the attitude angle of the carrier as it is traveling on the navigation route.

17. The navigation apparatus of claim 14, wherein the navigation route is defined by the signal processing unit basing on a starting location and a destination.

18. The navigation apparatus of claim 14, wherein the new navigation route is generated by the signal processing unit basing on a current location of the carrier indicated by the attitude angle and a destination.

19. The navigation apparatus of claim 14, wherein the display device is designed to display an operation interface thereon whose operations enables a starting location and a destination to be received by the signal processing unit for defining the navigation route.

20. The navigation apparatus of claim 14, wherein the display device is able to display a marking in correspondence to the coordinates of the carrier.

21. The navigation apparatus of claim 14, wherein the inertia navigation unit further comprises at least a gyroscopic sensor.

22. The navigation apparatus of claim 14, wherein the inertia navigation unit further comprises at least a differential module, and each differential module further comprises a pair of accelerometers, being arranged spacing from each other by a specific distance.

23. The navigation apparatus of claim 14, further comprising:
an acceleration sensing module, further comprising at least an accelerometer.
